(19) United States
(12) Patent Application Publication
(10) Pub. No.: US 2006/0158075 A1
(43) Pub. Date: Jul. 20, 2006

(54) Plasma display panel thermal dissipation-equilibration apparatus and mehtod

(75) Inventors: Yu-Kai Lin, Taisi Township (TW); Jiun-Han Wu, Sanchong City (TW); Yao-Ching Su, Taoyuan City (TW)

Correspondence Address: ARENT FOX PLLC, 1050 CONNECTICUT AVENUE, N.W., SUITE 400, WASHINGTON, DC, 20036, US

(73) Assignee: AU OPTRONICS CORPORATION

(21) Appl. No.: 11/034,969

(22) Filed: Jan. 14, 2005

(51) Int. Cl. H01J 7/24

(52) U.S. Cl. 313/46

(57) ABSTRACT

In a Plasma Display Panel (PDP) apparatus, system and method including a circuit framework structure, a chassis structure coupled to the circuit framework structure, at least one thermal pad structure coupled to the chassis structure, a panel structure coupled to the at least one thermal pad structure and including a display portion and a non-display portion, an integrated circuit disposed behind said non-display portion of said panel structure, and at least one attachment fastener structure, which couples the structures, deleterious heat that is generated during operation of associated ICs can be efficiently dissipated. Thermal equilibration of the PDP may also be obtained, thus increasing the operational life of the PDP.

### BACKGROUND OF THE INVENTION

1. Field of the Invention

The present invention relates to the field of flat-panel displays, particularly plasma display panels (“PDP”) technology, along with associated methods of heat dissipation and thermal management.

2. Related Art

Traditionally, various electronic devices have utilized heat sink devices either integrally configured or attached to dissipate heat in thermally deleterious heat generating components in such devices. The same is true with flat-panel display modules, such as liquid crystal display (“LCD”) and PDP technologies, which generate enormous heat quantities. Heat sinks have been utilized to quickly but relatively inefficiently dissipate the heat generated in integrated circuits (“IC”).

However, methods associated with heat sinks have several disadvantages. Heat sinks in flat-panel devices increase device costs, weight and dimensional thickness. All of these characteristics inevitably limit the application of heat sink configurations.

Various ICs can operationally endure temperatures as high as 70-85° C. However, high temperatures can adversely impact display performance characteristics of a flat-panel display. Therefore, there is present need to reduce the operational working temperature of ICs, without increasing costs, to reach the appropriate thermal balance in a display panel.

A conventional PDP display apparatus is depicted in FIG. 1. As shown in FIG. 1, a conventional heat sink 102 is attached to an IC 101 disposed on top of a printed circuit board (PCB) 103. The PDP 100 of FIG. 1 has a front panel 104 and a rear panel 105. A thermal pad 106 is disposed between the rear panel 105 and a chassis/base plate 107. Heat generated by the IC 101 is dissipated by the conventional heat sink 102 by means of conduction and convection, which is relatively inefficient.

As illustrated in FIG. 2, a conventional flat display PDP panel includes a front panel 201 and a rear panel 202. It can be further characterized, functionally, by a distinct display portion 203 and a non-display portion 204. As a consequence of operation, the temperature in the display portion 203 is higher than the temperature in the non-display portion 204. This temperature differential can produce thermal stresses, hot spots, and thermal fatigue, ultimately reducing the operational life or performance characteristics of the PDP.

One of the most significant threats to the operational performance and lifetime of a conventional PDP lies in deleterious thermal environments caused by generated heat. As explained above, a dramatic temperature differential between the display and non-display portions of a PDP can result in a degraded, fractured or inoperable PDP panel. Thus, there is a present need for an apparatus and method that prevents the compromised or operational failure of a PDP panel by reducing the temperature difference between those portions.

There is also a present need to reduce the ever-increasing temperature differentials over the operational and non-operational display portion, which lead to thermal expansion mis-match and structural fatigue performance of the displays.

Accordingly, the present invention provides such a robust, versatile and cost-effective solution to both heat dissipation and thermal equilibration of associated PDP structures and assemblies.

### SUMMARY OF THE INVENTION

The present invention has been made to solve the problems associated with the inability of a conventional PDP to provide a high level of efficiency in dissipating heat generated by associated ICs as described above.

The present invention is directed toward enhancing the thermal management characteristics of a PDP by utilizing an apparatus and method for conducting heat away from an IC and equilibrating temperature differentials within the PDP.

The present invention is directed toward permitting the efficient dissipation of deleterious heat that is generated during PDP operation of associated ICs.

At least one of the above features and advantages may be achieved by providing an apparatus including a circuit framework structure, a chassis structure coupled to the circuit framework structure, at least one thermal pad structure coupled to the chassis structure, a panel structure coupled to the at least one thermal pad structure and including a display portion and a non-display portion, an integrated circuit disposed behind said non-display portion of said panel structure, and at least one attachment fastener structure, which couples the circuit framework structure, chassis structure, panel structure, integrated circuit and the at least one thermal pad structure.

It is another feature of an embodiment of the present invention to utilize the heat generated by the ICs to achieve a thermally equilibrated state for the entire PDP, thus preventing the reduction in PDP panel operational life. This feature may be achieved by the thermal pad and/or chassis structure being disposed in the non-display portion of the plasma display panel. Thus, the present invention reduces the thermal imbalance between the display portion and the non-display portion in the PDP panel.

As can be indicated from above, another feature of an embodiment of the present invention is to reduce the operational temperature of the IC without increasing cost or dimensional thickness.

More specifically, it is a feature of an embodiment of the present invention to provide a more efficient plasma display panel thermal dissipation and equilibration apparatus compared to the conventional art. The apparatus is preferably configured such that a circuit framework structure, chassis structure and a panel structure, which has a display and non-display portion, that conducts heat away from an integrated circuit. The integrated circuit is preferably disposed behind said non-display portion of said panel structure, while a thermal pad structure provides the conduit of the IC generated heat. The thermal pad structure may be directly or indirectly thermally coupled to the integrated circuit. The integrated circuit is preferably disposed between the circuit framework structure and at least one thermal pad structure.

It is another feature of an embodiment of the present invention to provide a plasma display panel thermal dissipation and equilibration system. The system is configured such a circuit framework means, chassis means and a panel means, which has a display and non-display portion, conducts heat away from an integrated circuit. The integrated circuit is preferably disposed behind the non-display portion of the panel means, while a thermal pad means provides the conduit of the integrated circuit generated heat. The thermal pad means may be directly or indirectly thermally coupled to the integrated circuit. The integrated circuit is preferably disposed between the circuit framework means and at least one thermal pad means.

It is another feature of an embodiment of the present invention to a plasma display panel thermal dissipation and equilibration method. The method involves providing a circuit framework structure, chassis structure and a panel structure, which has a display and non-display portion, that conducts heat away from an integrated circuit. The method may further include disposing the integrated circuit behind the non-display portion of the panel structure, while providing a thermal pad structure as a conduit for the heat generated by the circuit. Alternately, a thermal pad structure is directly or indirectly thermally coupled to the integrated circuit. Finally, the integrated circuit is preferably disposed between the circuit framework structure and at least one thermal pad structure.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a cross-sectional view of a conventional PDP structure.

FIG. 2 illustrates a frontal view of a conventional PDP front and rear panel structures.

FIG. 3 illustrates a cross-sectional view of a PDP structure according to an embodiment of the present invention.

FIG. 4 illustrates a cross-sectional view of a PDP structure according to an alternate embodiment of the present invention.

FIG. 5 illustrates a cross-sectional view of the PDP structure with a Chip-on-Board configuration according to an alternate embodiment of the present invention.

FIG. 6 illustrates a frontal view of the PDP structure according to an alternate embodiment of the present invention.

FIG. 7 illustrates a cross-sectional view of the PDP structure according to an alternate embodiment of the present invention.

FIGS. 8 and 9 illustrate graphical representations of the temperature differential between the display portion and the non-display portion of PDP structures according to embodiments of the present invention.

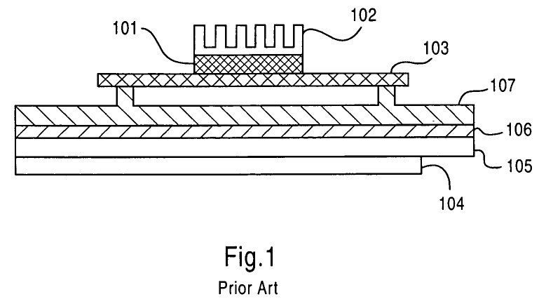

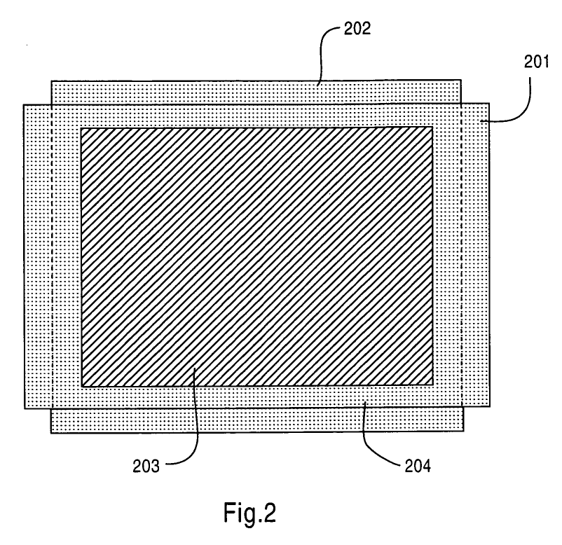

### DETAILED DESCRIPTION OF THE PREFERRED EMBODIMENTS

The following section describes various embodiments of the present invention based on drawings, while exemplifying the PDP thermal dissipation and equilibration apparatus, system and method of the present invention.

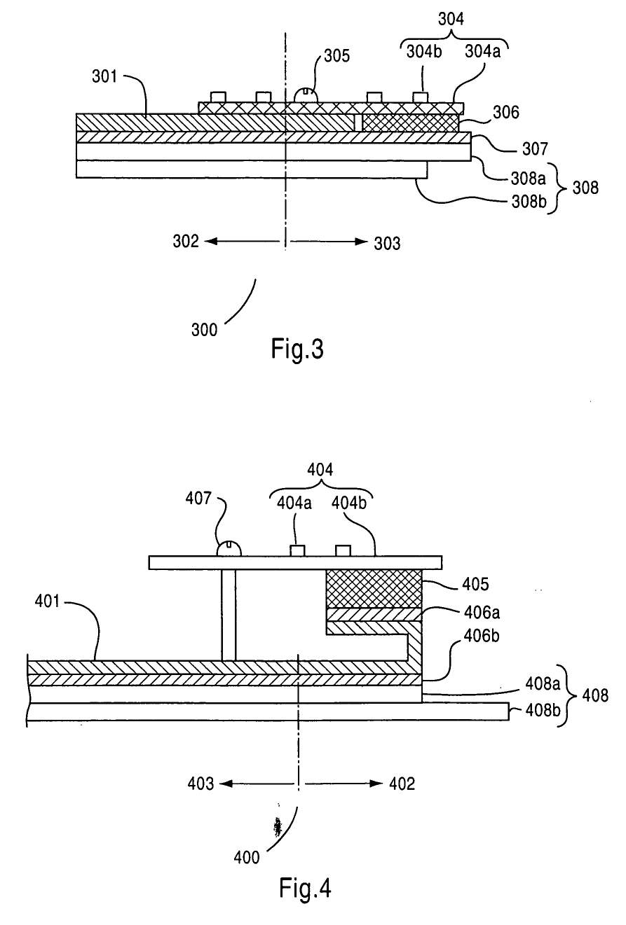

Accordingly, FIG. 3 illustrates a PDP 300 according to an embodiment of the present invention. The PDP 300 includes a chassis structure 301, which extends beyond a display portion 302 toward a non-display portion 303. The display portion 302 is that portion upon which a displayed image appears, as opposed to the non-display portion 303, where an image does not appear visible from the vantage point of a flat panel display viewer. A circuit framework structure 304, in this embodiment, includes a PCB 304a having circuit parts 304b. The PCB 304a is coupled to a chassis structure 301 by an attachment fastener structure 305. The attachment fastener structure 305 may be in various forms, e.g., securing screw, adhesive layer, etc. An IC 306 is disposed behind the non-display portion 303. The IC 306 is illustrated above the non-display portion 303 in FIG. 3. The IC is 306 directly thermally coupled to a thermal pad structure 307. The thermal pad structure 307 abuts a panel structure 308 including a rear panel structure 308a, which is attached to a front panel structure 308b.

More specifically, the thermal pad structure 307, in the non-display portion 303, is attached to the IC 306. The circuit framework structure 304 is attached and thermally coupled to the chassis structure 301. Therefore, the above-mentioned features are provided. The heat in the non-display portion 303 is dissipated and transferred through the thermal pad structure 307 toward the PDP panel structure 308 to achieve a thermally equilibrated state. Similarly, heat in the IC 306 is also transmitted to the chassis structure 301 by means of the thermal pad structure 307. Therefore, the configuration prevents the PDP 300 from operationally breaking down, at least due to extreme thermal stresses, without increasing the device cost.

The present invention is applicable to flat-panel display module packages, such as PDPs and flip-chip module packages, such as chip-on-glass (“COG”), chip-on-film (“COF”), and chip-on-board (“COB”).

FIG. 4 illustrates an alternate embodiment of the present invention wherein, similar to the embodiment of FIG. 3, a PDP 400 includes a chassis structure 401 that extends to a non-display portion 402, beyond a display portion 403. A circuit framework structure 404 includes several circuit components 404a that are attached to a PCB 404b. An IC 405 is directly thermally coupled to and disposed between a thermal pad structure 406a and the PCB 404b. It should be noted that the thermal pad structure 406b is disposed between the chassis structure 401 and a panel structure 408. An attachment fastener structure 407 secures the above-mentioned components to the chassis structure 401, which are in-turn coupled to a rear panel structure 408a and a front panel structure 408b of the panel structure 408. Therefore, in order to provide a feature of the present invention, this embodiment permits the operationally generated heat to be transferred to the non-display portion 402 so that a thermally equilibrated state is achieved. Thus, the PDP 400 will be less susceptible to thermally induced fractures and operational failures or degradations, as the temperature of the IC 405 can be lowered.

In addition, as shown in FIG. 4, the circuit framework structure 404 may be supported at an end thereof by a supporter 409. Alternately, the attachment fastener structure 407 may serve to support the circuit framework structure 404, as well as securing the same to the chassis structure 401.

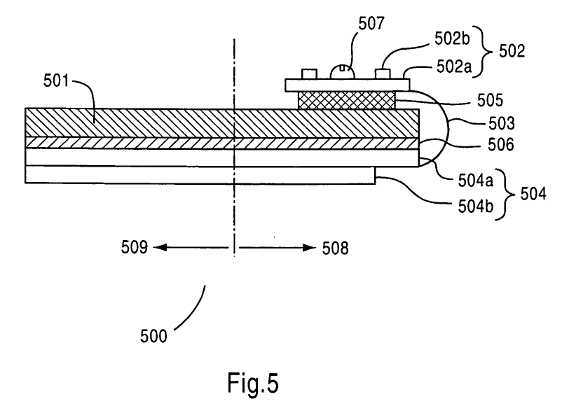

FIG. 5 illustrates an alternate embodiment of the present invention illustrating an example of one of various mechanical modules, e.g., chip-on-film (“COF”) (as illustrated) and chip-on-board (“COB”), for PDP 500 coupled to a chassis structure 501. A circuit framework structure 502 includes a PCB 502a having various circuit parts 502b, wherein a film 503 is attached and coupled to a panel structure 504. The panel structure 504 includes a rear panel structure 504a, which is attached to a front panel structure 504b. An IC 505 is indirectly thermally coupled to a thermal pad structure 506, wherein the IC 505 is disposed between the circuit framework structure 502 and a chassis structure 501. The thermal pad structure 506 is disposed between the chassis structure 501 and the rear panel structure 504a, wherein the above-mentioned components are secured together by means of an attachment fastener structure 507. In satisfaction of a feature of an embodiment of the present invention, the thermal pad structure 506 transfers heat generated from the IC 505, indirectly through the chassis structure 501, to the non-display portion 508, which lowers the temperature of the IC 505 and thereby achieves a thermally equilibrated state between a display portion 509 and a non-display portion 508 of the PDP 500.

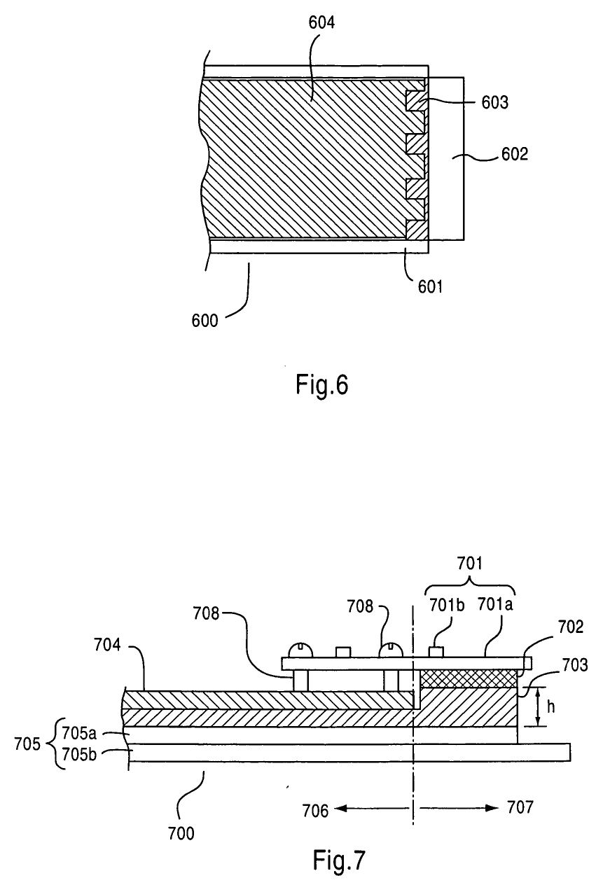

FIG. 6 illustrates an alternate embodiment of the present invention from a back view perspective of a PDP 600. A chassis structure 604 is disposed parallel to a rear panel structure 601 and a front panel structure 602. ICs (not shown) are coupled to thermal pad structures 603 disposed behind a chassis structure 604 in such a manner as to permit the transference of operationally generated heat to the non-display portion (not shown).

FIG. 7 illustrates an alternate embodiment of the present invention. As shown in FIG. 7, a PDP 700 includes a circuit framework structure 701, which includes a PCB 701a that has various circuit parts 701b attached thereto. An IC 702 is disposed between the PCB 701a and a thermal pad structure 703, wherein the height (“h”), e.g., thickness, of the thermal pad structure 703 has been increased. The thermal pad structure 703 is disposed between a chassis structure 704 and a panel structure 705, which includes a rear panel structure 705a and a front panel structure 705b in a display portion 706. In contrast, the thermal pad structure 703 is disposed between the IC 702 and the panel structure 705 in a non-display portion 707. The above-mentioned components are secured together by means of attachment fastener structures 708. In satisfaction of one of the features of the present invention, the thermal pad structure 703 transfers heat generated from the IC 702 directly to the non-display portion 707. Thus, the temperature of the IC 702 is lowered more efficiently, thereby achieving a thermally equilibrated state. In other words, the thermal pad structure 703 is increased in thickness in an alternative embodiment to more directly transfer heat to the panel structure 705 and the chassis structure 704.

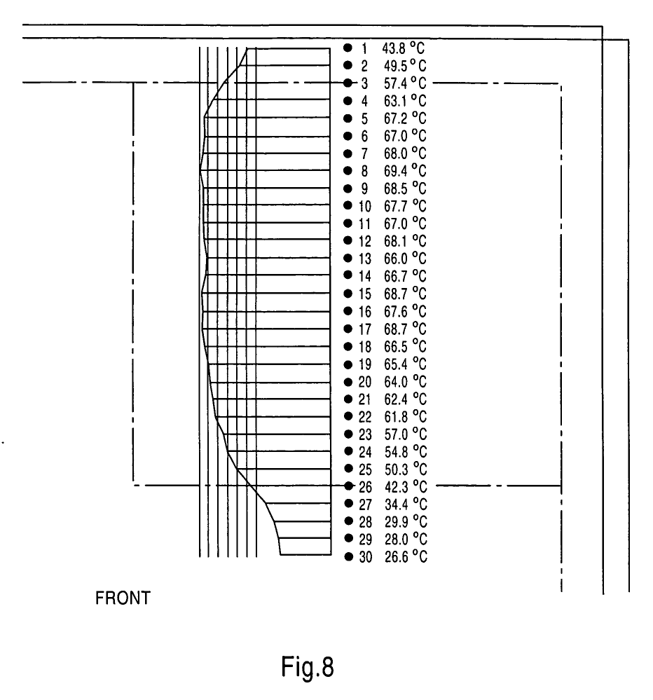

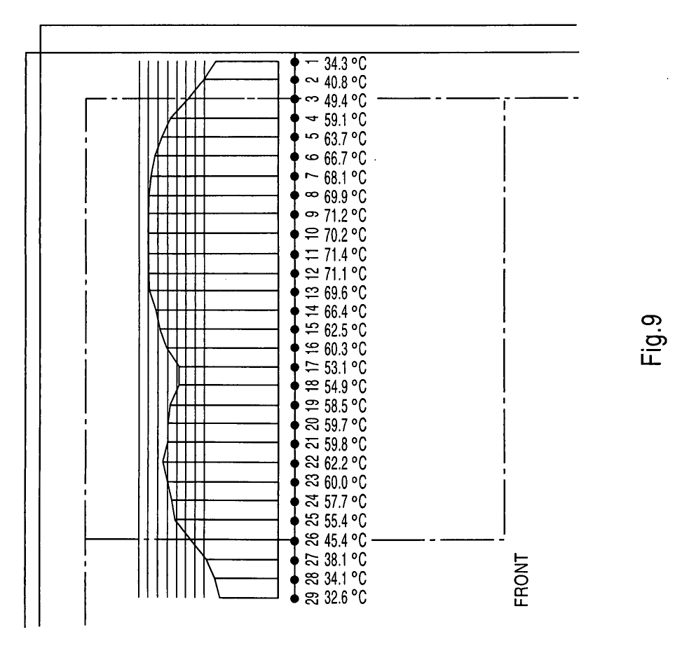

FIGS. 8 and 9 illustrate graphical representations of the temperature differential between the display portion and the non-display portion of the PDP structures of the present invention. The temperature differential was approximately 37° C. Conventionally, the operational temperature of the IC is in the range of 75° C.˜80° C. According to the present invention, the ICs are installed in the non-display portion of a PDP in a configuration that permits lowering and equilibration of a temperature differential between the display portion and non-display portion of the PDP. Therefore, since the operational temperature of the IC is reduced, the panel display structure can be protected from operational degradation.

Those skilled in the art will recognize that the device and methods of the present invention has many applications, and that the present invention is not limited to the representative examples disclosed herein. Although illustrative, the embodiments disclosed herein have a wide range of modification, change and substitution that is intended and in some instances some features of the present invention may be employed without a corresponding use of the other features.

Moreover, the scope of the present invention covers conventionally known variations and modifications to the system components described herein, as would be known by those skilled in the art. Accordingly, it is appropriate that the appended claims be construed broadly and in a manner consistent with the scope of the invention.

What is claimed is:

1. A plasma display panel thermal dissipation and equilibration apparatus, comprising:
a circuit framework structure;
a chassis structure coupled to the circuit framework structure;
at least one thermal pad structure coupled to the chassis structure;
a panel structure coupled to the at least one thermal pad structure and including a display portion and a non-display portion;
an integrated circuit disposed behind said non-display portion of said panel structure; and
at least one attachment fastener structure, which couples said circuit framework structure, chassis structure, panel structure, integrated circuit and said at least one thermal pad structure.

2. The plasma display panel thermal dissipation and equilibration apparatus according to claim 1, wherein said integrated circuit is disposed between said circuit framework structure and said at least one thermal pad structure.

3. The plasma display panel thermal dissipation and equilibration apparatus according to claim 1, wherein said at least one thermal pad structure is directly thermally coupled to said integrated circuit.

4. The plasma display panel thermal dissipation and equilibration apparatus according to claim 1, wherein said at least one thermal pad structure is indirectly thermally coupled to said integrated circuit.

5. The plasma display panel thermal dissipation and equilibration apparatus according to claim 1, wherein said circuit framework structure further comprises at least one printed circuit board.

6. The plasma display panel thermal dissipation and equilibration apparatus according to claim 1, wherein said panel structure includes a front panel structure and a rear panel structure.

7. A plasma display panel thermal dissipation and equilibration method, comprising:
providing a circuit framework structure;
providing a chassis structure coupled to the circuit framework structure;
providing at least one thermal pad structure coupled to the chassis structure;
providing a panel structure coupled to the at least one thermal pad structure and including a display portion and a non-display portion;
providing an integrated circuit disposed behind said non-display portion of said panel structure; and
providing at least one attachment fastener structure, which couples said circuit framework structure, chassis structure, panel structure, integrated circuit and said at least one thermal pad structure.

8. The plasma display panel thermal dissipation and equilibration method according to claim 7, wherein said integrated circuit is disposed between said circuit framework structure and said at least one thermal pad structure.

9. The plasma display panel thermal dissipation and equilibration method according to claim 7, wherein said at least one thermal pad structure is directly thermally coupled to said integrated circuit.

10. The plasma display panel thermal dissipation and equilibration method according to claim 7, wherein said at least one thermal pad structure is indirectly thermally coupled to said integrated circuit.

11. The plasma display panel thermal dissipation and equilibration method according to claim 7, wherein said circuit framework structure further comprises at least one printed circuit board.

12. The plasma display panel thermal dissipation and equilibration method according to claim 7, wherein said panel structure includes a front panel structure and a rear panel structure.
